(19) United States
(12) Patent Application Publication
(10) Pub. No.: US 2020/0190875 A1
(43) Pub. Date: Jun. 18, 2020

(54) Locking element stable under panel distortion

(71) Applicant: Dan Raz LTD., Tiral Carmel (IL)

(72) Inventor: Amir Raz, Haifa (IL)

(21) Appl. No.: 16/644,541

(22) PCT Filed: Sep. 7, 2017
(86) PCT No.: PCT/IL2017/051010

§ 371 Date: Mar. 5, 2020

(51) Int. Cl. E05C 3/30; E05B 63/00; E05C 3/12

(52) U.S. Cl. CPC E05C 3/30; E05B 63/0052; E05Y 2201/688; E05Y 2201/42; E05Y 2201/48; E05C 3/124

(57) ABSTRACT

A locking arrangement for a panel (10) mounted pivotally relative to a frame (12). The locking arrangement includes a locking element (14) mounted on the frame (12) so as to be pivotably about a pivot axis (16) parallel to an edge of the panel between a locked position engaged with the panel (10) and an unlocked position. A primary load bearing surface (202) of locking element (14) engages a pressure surface (204) of the panel oriented at an inclination to a plane of closure such that force applied to open panel (10) is opposed by compressive forces on locking element (14) acting towards frame (12). Locking element (14) also includes an anchoring configuration engaging a complementary feature of the panel to define a tensile engagement that opposes forces acting within the plane of closure to separate the panel from the frame.

### FIELD AND BACKGROUND OF THE INVENTION

The present invention relates to locking arrangements for panels, such as doors and windows and, in particular, it concerns locking arrangements with pivotally mounted locking elements.

It is known to provide pivotal locking elements to lock a panel to a frame, such as described in U.S. Pat. No. 8,707,625, coassigned with this invention.

### SUMMARY OF THE INVENTION

The present invention is a locking arrangement for panels, such as doors and windows.

According to the teachings of an embodiment of the present invention there is provided, an apparatus comprising: (a) an opening bounded by a frame, the frame defining a plane of closure; (b) a panel swingably mounted relative to the frame so as to be swingable between an open position removed from the opening and a closed position in which the panel is aligned parallel to the plane of closure; and (c) a locking element mounted on the frame and displaceable between a locked position in which the locking element is engaged with the panel thereby locking the panel to the frame, and an unlocked position in which the locking element is disengaged from the panel thereby unlocking the panel from the frame, wherein the locking element comprises a primary load bearing surface deployed such that, when the panel is in the closed position and the locking element is in the locked position, the primary load bearing surface engages a pressure surface of the panel oriented at an inclination to the plane of closure such that force applied to displace the panel towards the open position is opposed by compressive forces applied by the pressure surface to the locking element acting towards the frame, and wherein the locking element further comprises an anchoring configuration configured such that, when the panel is in the closed position and the locking element moves to the locked position, the anchoring configuration engages a complementary feature of the panel to define a tensile engagement configured to oppose forces acting within the plane of closure to separate the panel from the frame.

According to a further feature of an embodiment of the present invention, the primary load bearing surface and the anchoring configuration are rigidly interconnected or integrally formed as part of the locking element.

According to a further feature of an embodiment of the present invention, the locking element is pivotally mounted to the frame.

According to a further feature of an embodiment of the present invention, the anchoring configuration comprises a hook region of the locking element, and wherein the complementary feature of the panel is an undercut surface in a recess of the panel.

According to a further feature of an embodiment of the present invention, the locking element is pivotally mounted so as to be pivotable about a pivot axis, and wherein at least part of an engagement contact area between the hook region and the undercut surface is located to the door-opening side of a plane parallel to the plane of closure passing through the pivot axis.

According to a further feature of an embodiment of the present invention, the frame comprises a stopper deployed to abut a surface of the locking element in the locked position so as to limit rotation of the locking element.

According to a further feature of an embodiment of the present invention, at least part of the primary load bearing surface is a flat surface, and at least part of the pressure surface is a flat surface.

According to a further feature of an embodiment of the present invention, the locking element is resiliently biased to move from the unlocked position towards the locked position, and wherein the locking element further comprises a roller element deployed so as to provide a rolling contact surface positioned to be contacted by the panel on swinging from the open position to the closed position, thereby displacing the locking element towards the unlocked position to allow closing of the panel.

There is also provided according to the teachings of an embodiment of the present invention, an apparatus comprising: (a) an opening bounded by a frame, the frame defining a plane of closure; (b) a panel swingably mounted relative to the frame so as to be swingable between an open position removed from the opening and a closed position in which the panel is aligned parallel to the plane of closure; and (c) a locking element mounted on the frame so as to he pivotable about a pivot axis parallel to an edge of the panel between a locked position in which the locking element is engaged with the panel thereby locking the panel to the frame, and an unlocked position in which the locking element is disengaged from the panel thereby unlocking the panel from the frame, wherein the locking element comprises a convex primary load bearing surface deployed such that, when the panel is in the closed position and the locking element is in the locked position, forces applied to the panel directed to displace the panel towards the open position are transferred via the primary load bearing surface to the frame, and wherein a region of the panel contacting the convex primary load bearing surface has a shape non-complemental to the convex primary load bearing surface so as to accommodate sliding motion of the region of contact over the convex primary load bearing surface resulting from flexion deformation of the panel while maintaining effective force transfer from the panel to the locking element.

According to a further feature of an embodiment of the present invention, the convex primary load bearing surface has a partial cylindrical form.

According to a further feature of an embodiment of the present invention, the pivot axis is an axis of the partial cylindrical form.

According to a further feature of an embodiment of the present invention, the convex primary load bearing surface has an angular extent of at least 30° around the pivot axis.

According to a further feature of an embodiment of the present invention, the frame further comprises an angular stop deployed to abut part of the locking element in the locked position so as to prevent pivoting of the locking element beyond the locked position.

According to a further feature of an embodiment of the present invention, the region of the panel contacting the convex primary load bearing surface is an edge of the panel. According to an alternative feature of an embodiment of the present invention, the region of the panel contacting the convex primary load bearing surface is a flat region. According to a further alternative feature of an embodiment of the present invention, the region of the panel contacting the convex primary load bearing surface is a convex region.

There is also provided according to the teachings of an embodiment of the present invention, an apparatus comprising: (a) an opening bounded by a frame, the frame defining a plane of closure; (b) a panel swingably mounted relative to the frame so as to be swingable between an open position removed from the opening and a closed position in which the panel is aligned parallel to the plane of closure; (c) a locking element mounted on the frame so as to be pivotable about a pivot axis parallel to an edge of the panel between a locked position in which the locking element is engaged with the panel thereby locking the panel to the frame, and an unlocked position in which the locking element is disengaged from the panel thereby unlocking the panel from the frame, the locking element being resiliently biased to move from the unlocked position towards the locked position, wherein the locking element comprises a roller element deployed so as to provide a rolling contact surface positioned to be contacted by the panel on swinging from the open position to the closed position, thereby displacing the locking element towards the unlocked position to allow closing of the panel.

According to a further feature of an embodiment of the present invention, the locking element has a primary load bearing surface deployed such that, when the panel is in the closed position and the locking element is in the locked position, forces applied to the panel directed to displace the panel towards the open position are transferred via the primary load bearing surface to the frame, and wherein the roller element is configured to project from the primary load bearing surface.

According to a further feature of an embodiment of the present invention, the locking element comprises at least one secondary roller element, the roller element and the secondary roller element deployed to come sequentially into contact with the panel during closing of the panel and motion of the locking element to the locked position.

According to a further feature of an embodiment of the present invention, the locking element is an elongated locking element extending parallel to an edge of the panel and extending along at least about 10% of a length of the edge of the panel.

According to a further feature of an embodiment of the present invention, the locking element is an elongated locking element extending parallel to an edge of the panel and extending along a majority of a length of the edge of the panel.

The phrase “mounted on” as used herein refers to a first element affixed to a second element in any disposition between the two elements including the first element disposed on the second element, inside the second element, affixed to any outer or inner surface of the second element, etc.

The phrase “defined on” as used herein refers to a feature or an element provided on a member in any manner, including integrally formed with the member, attached to the member etc.

The term “panel” is used to refer to the element deployed across at least part of an opening in the closed state. The panels and corresponding closures may be doors, windows or any other type of opening which is selectively closed (or partially closed) by a hinged or otherwise swinging panel. The term “panel” as used herein the specification and claims refers generically to any moving panel configured to selectively block off and allow access through an opening to a structure, such as a building or vehicle, an entrance to a confined area, or between two confined areas including hinged door, sliding door, a window of any type, as well as a hood and a trunk for covering vehicles or portions thereof, etc.

### BRIEF DESCRIPTION OF THE DRAWINGS

The invention is herein described, by way of example only, with reference to the accompanying drawings, wherein:

FIG. 1A is a horizontal cross-sectional view taken through a locking arrangement for locking a panel to a frame, constructed and operative according to an embodiment of the present invention, shown in a locked state;

FIGS. 1B and 1C are views similar to FIG. 1A illustrating changes in the locking geometry occurring when increasing levels of force are applied to the panel;

FIGS. 2A-2C are views similar to FIGS. 1A-1C, respectively, illustrating an application of the invention to a thin rigid panel, such as a glass panel;

FIGS. 3A-3C are horizontal cross-sectional views taken through a locking arrangement for locking a panel to a frame, constructed and operative according to a further embodiment of the present invention, shown in a locked state, an unlocked state and an open state, respectively;

FIGS. 4A-4C are views similar to FIG. 3A illustrating changes in the locking geometry occurring when increasing levels of force are applied to the panel;

FIG. 5 is a view similar to FIG. 3A illustrating a first variant of the locking arrangement of FIG. 3A;

FIGS. 6A and 6B are views similar to FIG. 3A illustrating a second variant of the locking arrangement of FIG. 3A, shown without and with force-induced deformation;

FIGS. 7A-7F are horizontal cross-sectional views taken through a locking arrangement for locking a panel to a frame, constructed and operative according to a further embodiment of the present invention employing roller elements, shown in a sequence of positions during closing and locking of the panel;

FIGS. 8A-8H are horizontal cross-sectional views taken through a locking arrangement for locking a panel to a frame, constructed and operative according to a variant of the embodiment of FIG. 3A employing roller elements, shown in a sequence of positions during closing and locking of the panel;

FIG. 9 is a horizontal cross-sectional view taken through a closure showing a locking arrangement for locking a panel to a frame, constructed and operative according to a further embodiment of the present invention, shown in a locked state;

FIG. 10 is a cut-away isometric view of the locking arrangement of FIG. 9;

FIGS. 11A-11G are horizontal cross-sectional views taken through the locking arrangement of FIG. 9 showing a sequence of states during operation of an actuator to unlock the locking arrangement; and

FIGS. 12A-12F are horizontal cross-sectional views taken through the locking arrangement of FIG. 9 showing a sequence of states during closing of the panel without operation of the actuator.

### DESCRIPTION OF THE PREFERRED EMBODIMENTS

The present invention is a locking arrangement for panels, such as doors and windows.

The principles and operation of locking arrangements according to the present invention may be better understood with reference to the drawings and the accompanying description.

By way of introduction, referring generically to all of the drawings, the present invention provides locking arrangements for a panel 10 that is swingably (typically pivotally) mounted relative to a frame 12 so as to be swingable between an open position removed from an opening and a closed position in which panel 10 is aligned parallel to a plane of closure across at least part of the opening. The locking arrangement includes a locking element 14 that is mounted on frame 12 so as to be displaceable, typically pivotably about a pivot axis 16 parallel to an edge of panel 10, between a locked position in which locking element 14 is engaged with panel 10, thereby locking panel 10 to frame 12, and an unlocked position in which locking element 14 is disengaged from panel 10, thereby unlocking panel 10 from frame 12.

The geometry of locking using such a pivotally-mounted locking element typically ensures that forces opposing opening of the panel are directed at an oblique angle with respect to the panel, and in some cases are converted primarily, if not exclusively, into compressive forces on the locking element. This provides enhanced security of locking for a given locking element compared to a similar locking element that is exposed to bending or shear forces (that commonly dominate in conventional bolts). These properties can optionally be combined with the use of a locking element which is elongated along a significant portion (typically at least 10%, and in some cases along a majority) of a dimension of the panel, this configuration results in highly secure locking, even when using relatively soft materials. Thus, according to certain preferred embodiments of the present invention, the locking element may in fact be formed from relatively soft materials, such as various polymer materials, and may employ various combinations of materials as layers, coatings or composites. Similarly, where locking forces are widely spread along the dimensions of the panel and frame, relatively soft materials, such as various polymers, may be used for implementing part or all of the panel and/or the frame.

Within the above context, various aspects of the present invention provide enhancements particularly relating to geometrical stability of locking under a range of operating conditions, including flexion deformation of panel 10 which may occur under conditions of heavy loading.

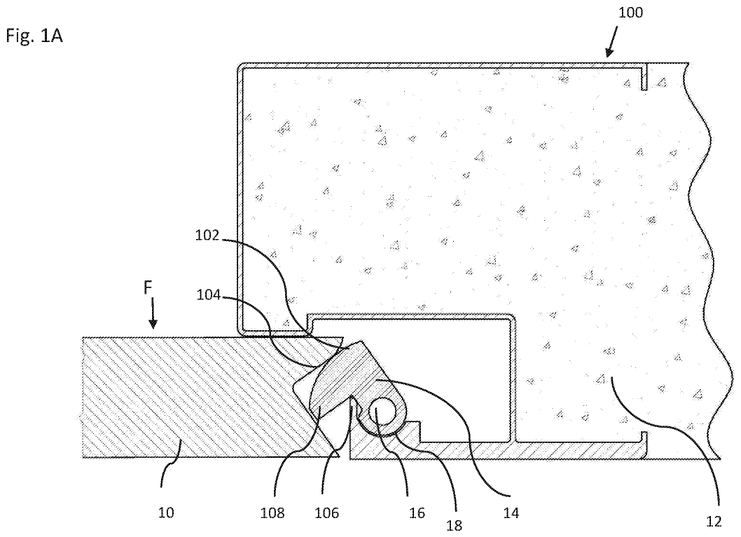

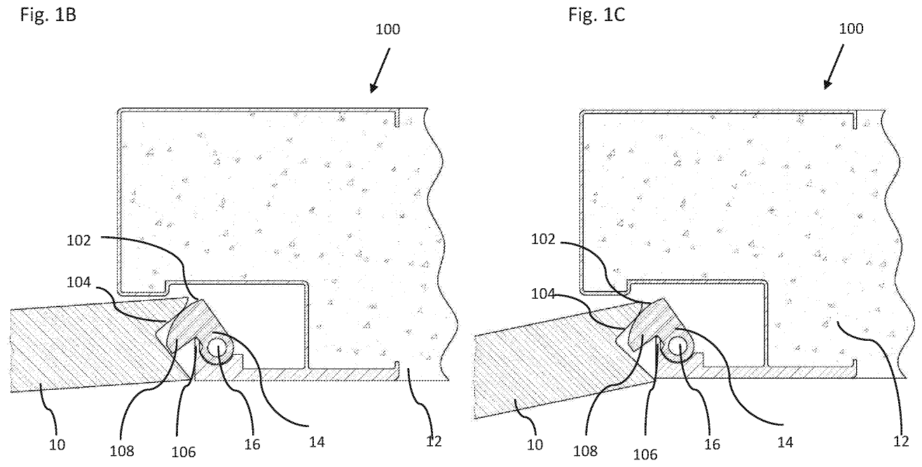

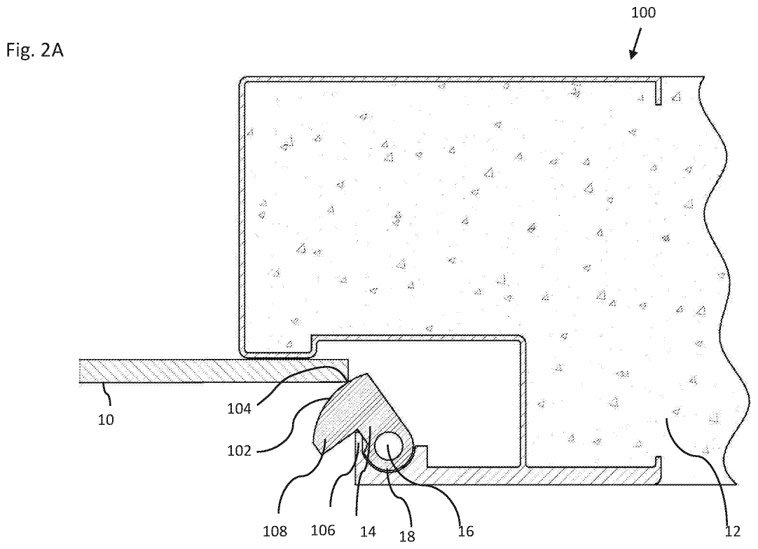

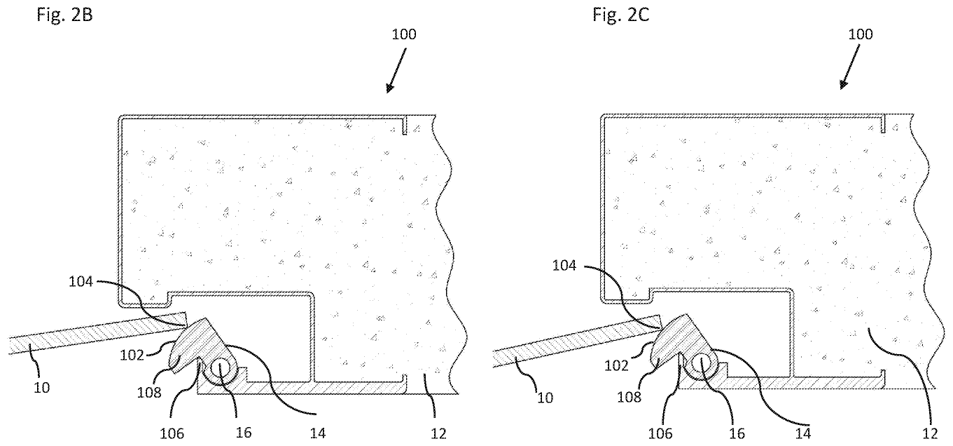

Referring now to the drawings, FIGS. 1A-2C illustrate one such locking configuration, generally designated 100, in which locking element 14 has a convex primary load bearing surface 102 deployed such that, when panel 10 is in the closed position and locking element 14 is in the locked position (FIGS. 1 A and 2A), forces F applied to panel 10 directed to displace the panel towards its open position are transferred via primary load bearing surface 102 to frame 12. Primary load bearing surface 102 contacts a region 104 of panel 10 which has a shape non-complemental to the form of convex primary load hearing surface 102. “Non-complemental” in this context refers to a surface which is not shaped for close-fitting (complemental) engagement with the convex shape of surface 102. Preferred but non-limiting examples of such non-complemental shapes include a flat region and a convex region. In some cases, as illustrated in FIGS. 2A-2C, the contact region 104 is an edge of panel 10, such as the edge formed at the intersection of one of the major faces of the panel with a lateral side of the panel.

As a result of the use of a convex primary load bearing surface 102 together with a non-complemental cooperating region 104, contact between panel 10 and locking element 14 preferably occurs along a contact profile approximating to a line or a thin strip, thereby enhancing the ability of the locking arrangement to accommodate relative motion between panel 10 and locking element 14, such as typically occurs when panel 10 is flexed or otherwise deformed by exposure to heavy loading. Specifically, as illustrated in FIGS. 1B, 1C, 2B and 2C, for a panel undergoing sufficient loading to cause flexion (bowing) of the panel, the region of panel 10 near the locking arrangement undergoes both rotation and “shortening” in that it moves away from the frame. The localized line of contact between locking element 14 and panel 10 facilitates sliding of the line of contact across the surfaces and/or a rolling motion of the region of contact over the convex primary load bearing surface while maintaining effective force transfer from panel 10 to locking element 14, as shown.

A preferred, but non-limiting, form of convex primary load bearing surface 102 is a partial cylindrical form, which may advantageously be configured with pivot axis 16 as the axis of the partial cylindrical form, as illustrated. Alternatively, the axis of the partial cylindrical form may optionally be slightly offset towards the panel, so that the applied angle of pressure of panel 10 acting on locking element 14 tends to generate a net moment tending to maintain locking element 14 in its locked position. A stop 106, formed as part of frame 12, preferably abuts part of locking element 14 in its locked position so as to prevent pivoting of locking element 14 beyond the locked position.

In certain embodiments, convex primary load bearing surface 102 preferably has an angular extent of at least 30° around pivot axis 16, thereby accommodating a correspondingly wide range of relative motion and/or rotation between panel 10 and frame 12. In certain cases, it is preferably for transfer of forced from panel 10 to frame 12 to be primarily, or exclusively, via compressive forces passed through locking element 14. However, particularly where a large angular extent of locking element is provided, a solid-block implementation of locking element 14 is not required. Thus, in the implementation illustrated here, locking element 14 includes a lateral extension 108 which supports part of primary load bearing surface 102, and which wraps around stop 106, such that any load applied near the end of surface 102 would be opposed primarily as a bending moment applied to locking element 14.

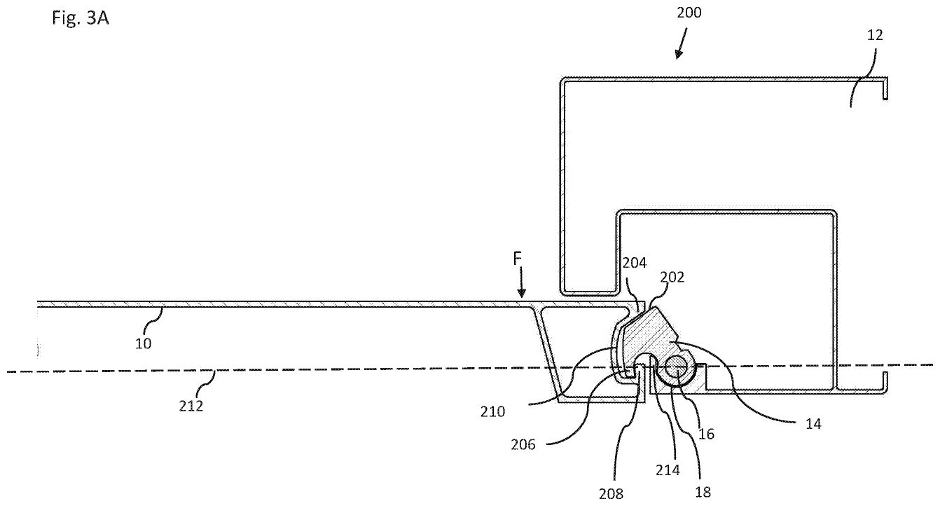

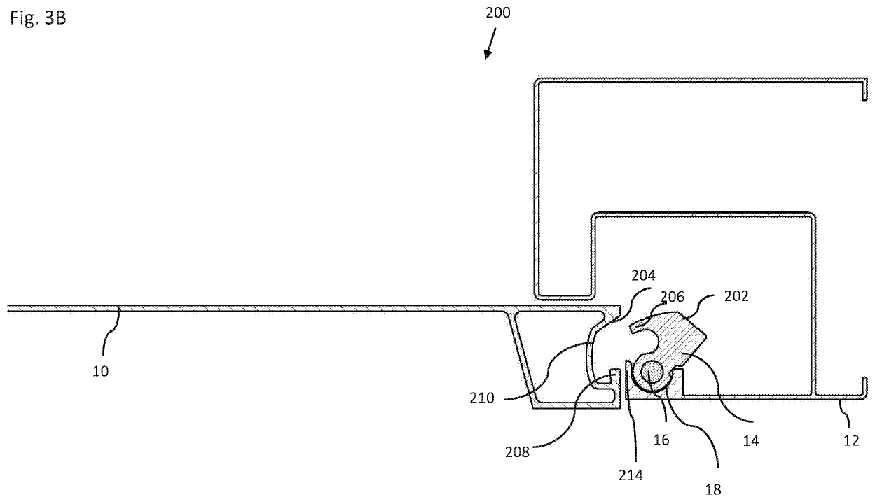

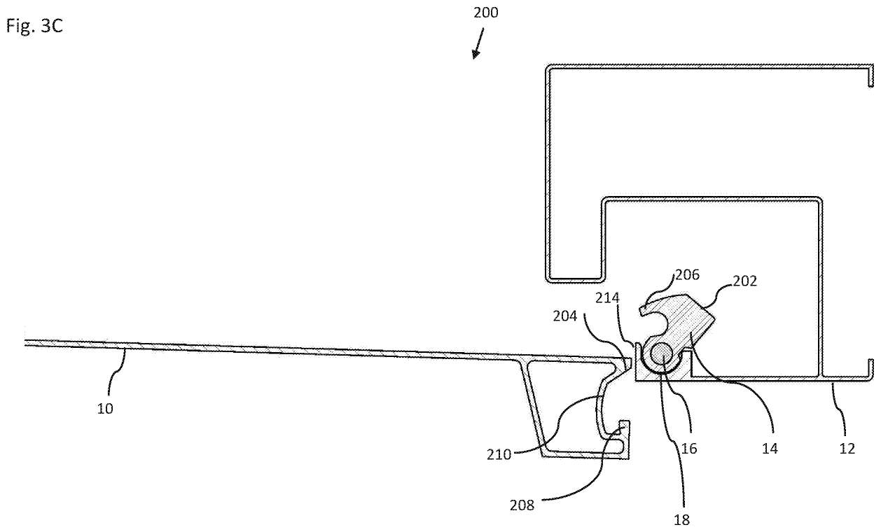

Turning now to FIGS. 3A-6B, these illustrate a locking arrangement, generally designated 200, according to a further aspect of the present invention. In this case, locking element 14 has a primary load bearing surface 202 deployed such that, when panel 10 is in its closed position and locking element 14 is in its locked position, primary load bearing surface 202 engages a pressure surface 204 of the panel oriented at an inclination to the plane of closure such that force F applied to displace panel 10 towards its open position is opposed by compressive forces applied by pressure surface 204 to locking element 14 acting towards frame 12. In addition, locking element 14 further includes an anchoring configuration configured such that, when panel 10 is in the closed position and locking element 14 moves to its locked position, the anchoring configuration engages a complementary feature of panel 10 to define a tensile engagement configured to oppose forces acting within the plane of closure to separate the panel from the frame.

The phrase “tensile engagement” is used herein to refer to any form of engagement which is able to withstand tensile forces acting within the plane of closure, or at angles close to the plane of closure which may be encountered during bowing (flexion deformation) of panel 10 under loading. In the particularly preferred but non-limiting example illustrated here, the anchoring configuration includes a hook region 206 of locking element 14, and the complementary feature of the panel is an undercut surface 208 in a recess 210 of panel 10. The term “hook region” is used herein to refer to any portion of locking element 14 which provides a bearing surface oriented to face generally towards pivot axis 16, such as within ±10° from a radial direction towards pivot axis 16. In certain cases, the hook region may be oriented with a negative angle, meaning that it faces slightly inwards towards a recess in locking element above pivot axis 16 in the orientation as illustrated here, thereby achieving positive interlocking engagement. Additionally, or alternatively, at least part of an engagement contact area between hook region 206 and undercut surface 208 is preferably located to the door-opening side (i.e., below as illustrated here) of a plane 212 parallel to the plane of closure and passing through pivot axis 16.

Hook region 206 and primary load bearing surface 202 are preferably rigidly interconnected or integrally formed as part of locking element 14. Frame 12 preferably includes a stopper 214, which may be an extension of a support wall 18 forming a socket around the base of locking element 14. Stopper 214 is preferably deployed to abut a surface of locking element 14 in the locked position so as to limit rotation of the locking element. Stopper 214 and/or other surfaces of support wall 18 preferably provide support to locking element 14 to retain the locking element under tension which would tend to pull the locking element away from frame 12 in the plane of closure.

In certain particularly preferred implementations, at least part of primary load bearing surface 202 is a flat surface, and at least part of pressure surface 204 is a flat surface.

The operation and functionality of locking arrangement 200 will now be understood. FIGS. 3A-3C illustrate normal operation of the locking arrangement, transitioning from the locked state of FIG. 3A through an unlocked state (FIG. 3B) to an open state (FIG. 3C). Details of an actuating mechanism for displacing locking element 14 in order to unlock the arrangement are omitted here for clarity, as discussed further below.

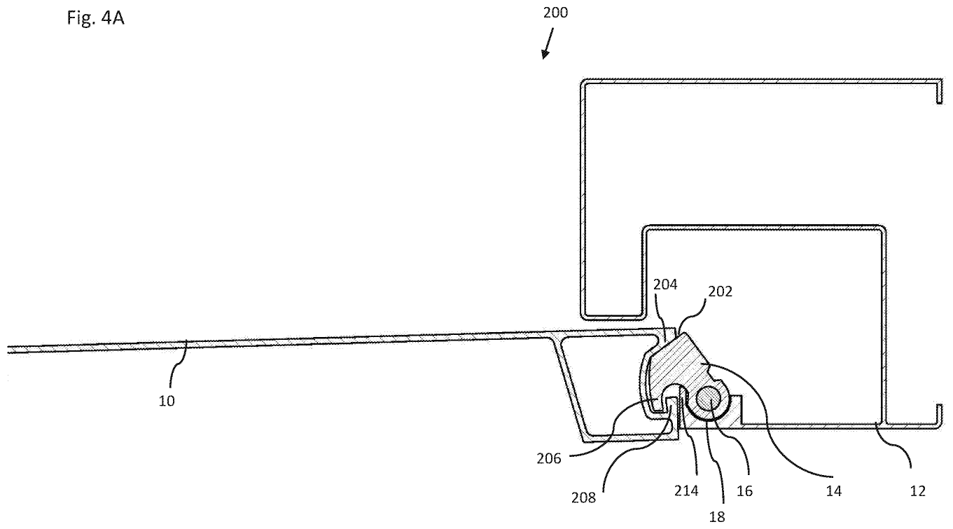

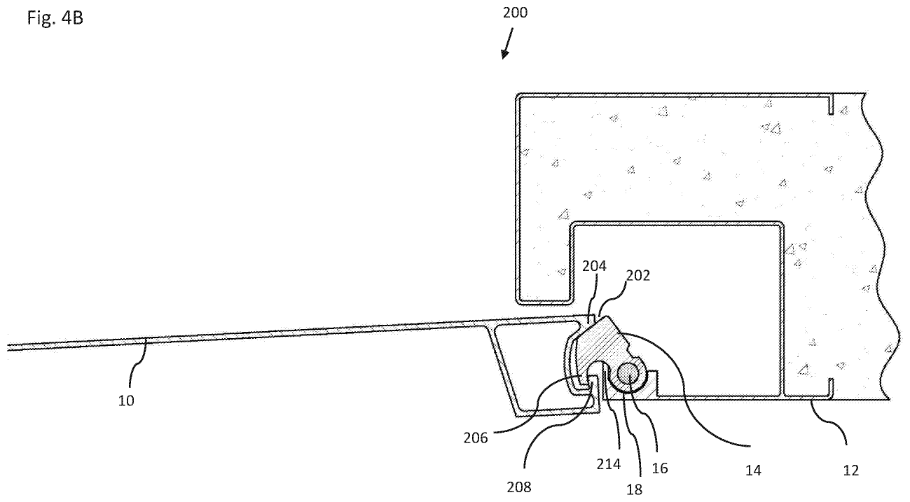

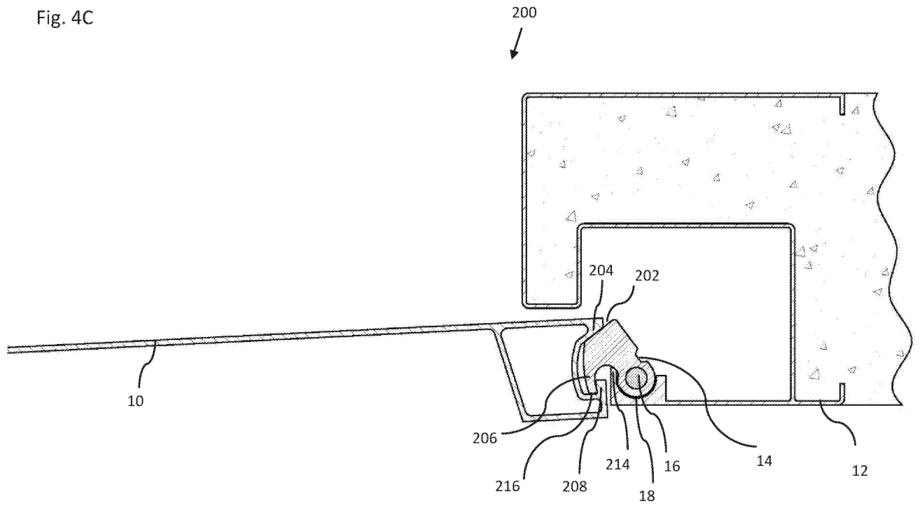

FIGS. 4A-4C illustrate the operation of locking arrangement 200 under conditions of increasing load applied to panel 10 causing increasing bowing (deformation) of the panel. As shown in FIG. 4A, the increasing load is primarily borne by primary load bearing surface 202, which transfers that load, mostly as compressive forces, through locking element 14 to frame 12. Under these conditions, the tensile anchoring arrangement is typically unstressed, as seen by a small gap between hook region 206 and undercut surface 208. As the load further increases, and the panel becomes further bowed. In addition to increasing the load on surface 202, the bowing of the panel also results in “shortening” of the panel, through which the edge tries to pull away from the frame. These forces are opposed by engagement of hook region 206 with undercut surface 208 as illustrated in FIG. 4B. The combined effect of the forces applied by surface 202 and hook region 206 achieves highly effective retention of the edge of panel 10, where the primary frontal forces are transferred by compression via surface 202 through locking element 14 to the frame while the tensile engagement maintains the required interlocking geometry between the panel and the locking element, and ensures that the edge of the panel is not extracted from the locking arrangement.

Depending on the length of hook region 206, the length of undercut surface 208 and the degree of deformation, in some cases, an end surface 216 of hook region 206 may come into abutment with an end of the corresponding undercut in the panel as shown in FIG. 4C. This additional point of contact may further contribute to the geometrical stability of the interlocking configuration, and may add an additional wedge-tightening effect between end surface 216 and primary load bearing surface 202 against the corresponding surfaces of the panel.

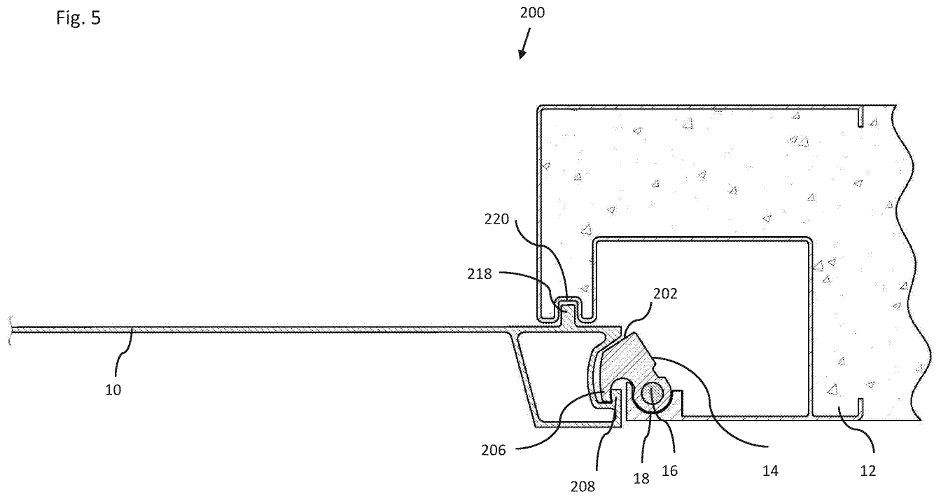

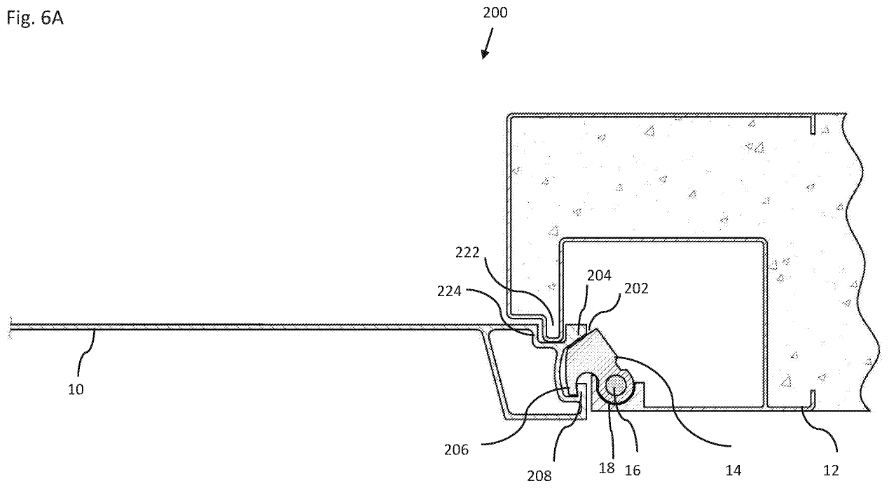

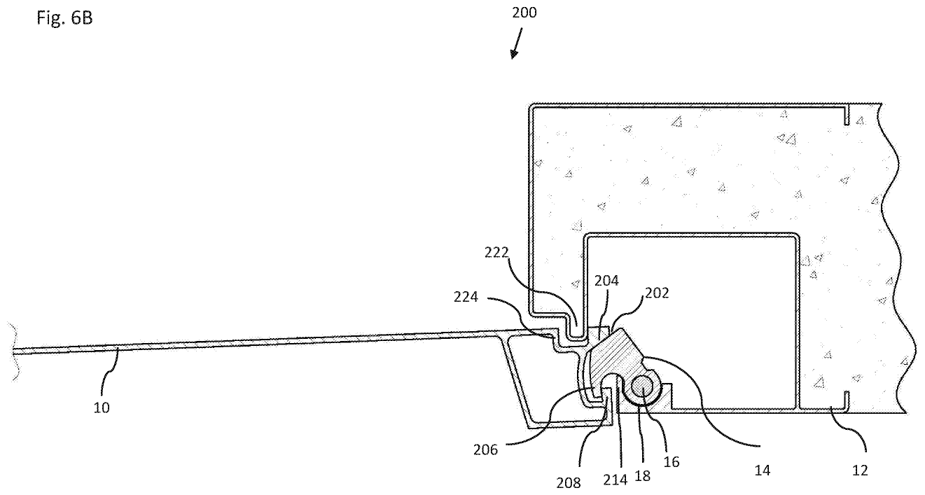

The configuration of locking arrangement 200 described thus far is believed to be highly effective at enhancing the ability of locking arrangements with pivotally mounted locking elements to withstand conditions of high loading and deformation, and in particular, to prevent withdrawal of the panel from the locking arrangement. FIGS. 5 and 6A-6B illustrate optional additional features which may further enhance the load-bearing stability of the arrangement.

Specifically, FIG. 5 illustrates an implementation of locking arrangement 200 in which panel 10 is provided with an additional projecting ridge 218 which engages a complementary recess 220 in frame 12. FIG. 6A illustrates a similar but inverted configuration in which a projecting ridge 222 projects from frame 12 to engage a corresponding slot 224 in panel 10. FIG. 6B illustrates the performance of this modified arrangement under heavy loading. The function of locking element 14 remains essentially as before, but projecting ridge 222 provides supplementary resistance to forces within the plane of closure trying to separate the panel from the frame. The juxtaposition of primary load bearing surface 202 and projecting ridge 222 also provides a pinching retention effect for retaining an edge bead of the panel. Similar effects are also provided by the configuration of FIG. 5.

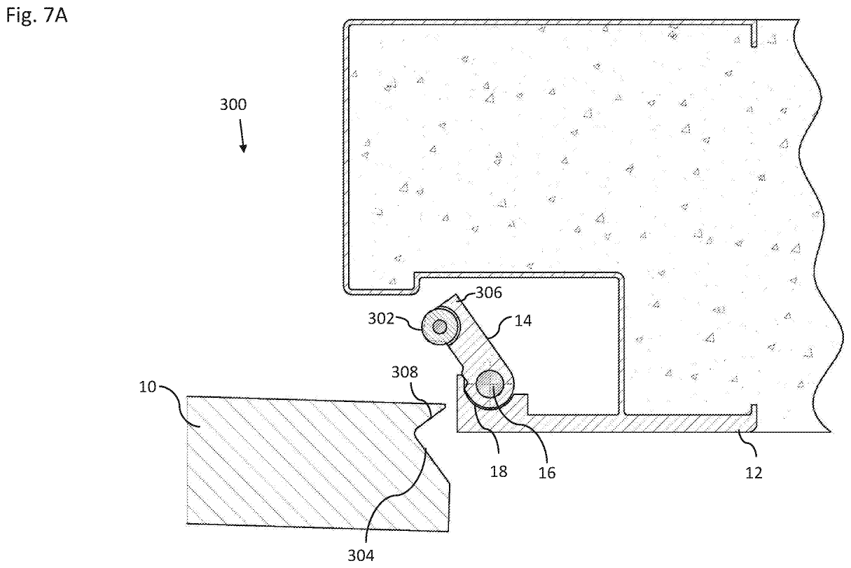

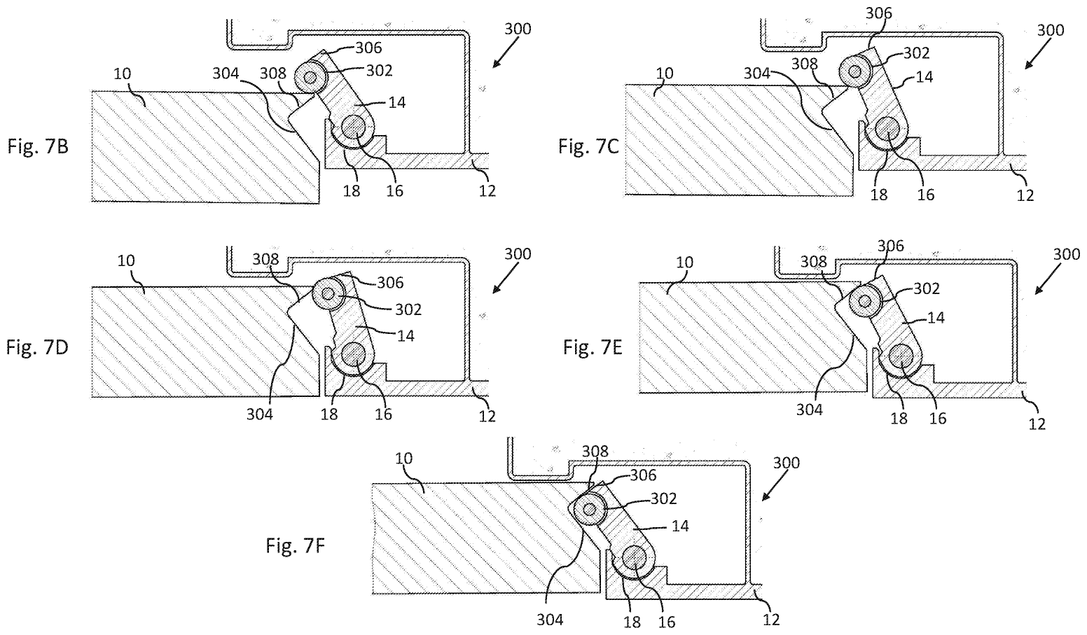

Turning now to FIGS. 7A-7F, there is illustrated a locking arrangement, generally designated 300, constructed and operative according to a further aspect of the present invention, which may be used to advantage together with the features described thus far in this document, but which is not limited to that context. According to this aspect of the invention, one or more roller element is preferably associated with locking element 14 to reduce friction during locking, unlocking and slamming of the panel, and to help accommodate manufacturing tolerances and/or any warping of elements which may occur during the lifetime of the system.

All of the locking arrangements of the present invention typically employ resilient biasing of locking element 14 towards its locked position. The resilient biasing may be provided by a leaf spring (not shown) or any other suitable spring element or biasing mechanism. The resilient biasing helps to engage locking element 14 with panel 10 to achieve locking when the panel is closed, and also facilitates resilient retraction of locking element during closing of the panel.

According to this aspect of the invention, locking element 14 includes a roller element 302 deployed so as to provide a rolling contact surface positioned to be contacted by the panel on swinging from the open position to the closed position. The sequence of FIGS. 7A-7F illustrates the process of closing and locking of the panel according to this aspect of the invention. Specifically, according to the particularly preferred implementation illustrated here, roller element 302 is positioned to be the first element encountered by part of panel 10 during a closing motion of the panel, as shown in FIG. 7B. Pressure of panel 10 against roller element 302 causes locking element 14 to retract against the resilient bias, as shown in FIGS. 7C and 7D, allowing the panel to pass by locking element 14 to reach its fully closed position.

As the closing motion of the panel continues, locking element 14 encounters a recess 304 in panel 10 (or in alternative implementations, the rear surface of the panel) and starts to spring back towards its locked position under influence of the biasing arrangement. This motion is illustrated in FIGS. 7E and 7F, the latter corresponding to the locked position of the locking arrangement.

In addition to reducing friction as the panel forces retraction of the locking element, preferred implementations of the present invention also provide roller-based friction reduction during engagement of locking element 14 against panel 10. In the particularly preferred implementation shown here, the aforementioned roller element 302 is also configured to project from a primary load bearing surface 306 so as to reduce friction between locking element 14 and panel 10 during the normal (unloaded) locking and unlocking motions.

Although the use of a single roller element 302 as shown is particularly simple and effective, it will be clear that alternative implementations may employ two or more roller elements 302 deployed to come sequentially into contact with panel 10 during closing of the panel and/or motion of the locking element to the locked position. Additionally, each roller element 302 is typically one of a number of localized roller elements spaced along a length dimension of locking element.

Roller elements 302 may be implemented using any rolling element which is effective to reduce friction. Most preferably, a ball bearing assembly or cylindrical roller bearings are used for highly effective friction reduction. Such bearings per se are well known, and will not be described here in detail. It should be understood that roller elements or bearings of this type may be included with any of the embodiments of the present invention described herein, as will be clear to a person ordinarily skilled in the art.

While it is possible to implement roller element 302 as a load bearing element, according to particularly preferred implementations of the present invention, roller elements 302 are employed for friction reduction and tolerance matching, while the main load bearing capabilities of the locking arrangement are provided by non-rolling surfaces. Thus, for example, as illustrated in the locked state of FIG. 7F, there is preferably a small clearance between primary load bearing surface 306 and the facing pressure surface 308 of panel 10. Under normal unloaded conditions, locking and unlocking of the panel occurs through a rolling motion of roller element 302 across pressure surface 308 while surface 306 does not touch surface 308 (or optionally comes into contact at the very end of the locking motion). Roller element 302 is either resiliently mounted or is configured to give way under loads above a certain threshold as the gap closes and the load is transferred to direct contact between surfaces 306 and 308.

In particularly preferred implementations, roller elements 302 project at least about 1 millimeter above the surrounding surfaces, and in some cases 2 or more millimeters, to provide sufficient clearance to accommodate manufacturing tolerances and/or slight warping of components which might occur during the lifetime of the system. These clearance gaps close during the initial stages of application of a load to the system such that the overall security and load-bearing performance of the locking arrangement is substantially unaffected by the presence of the roller elements.

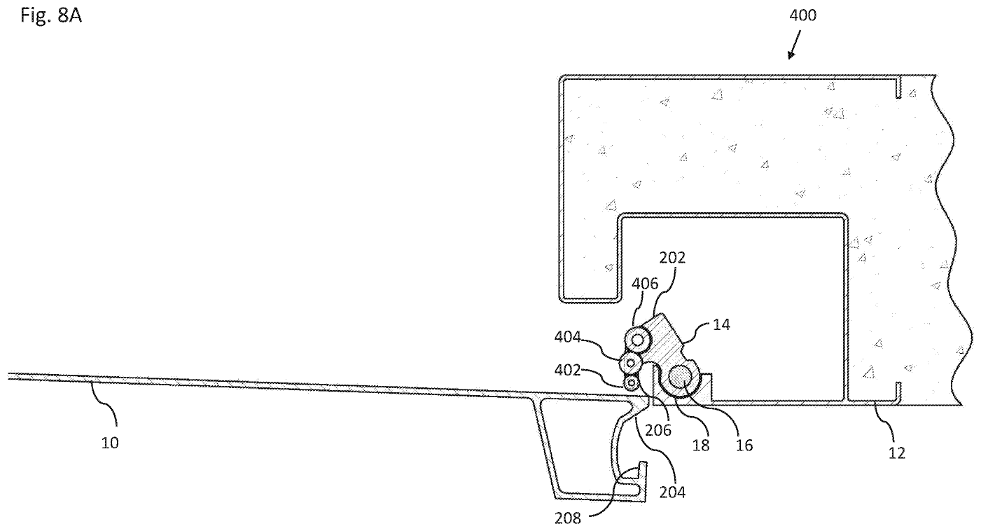

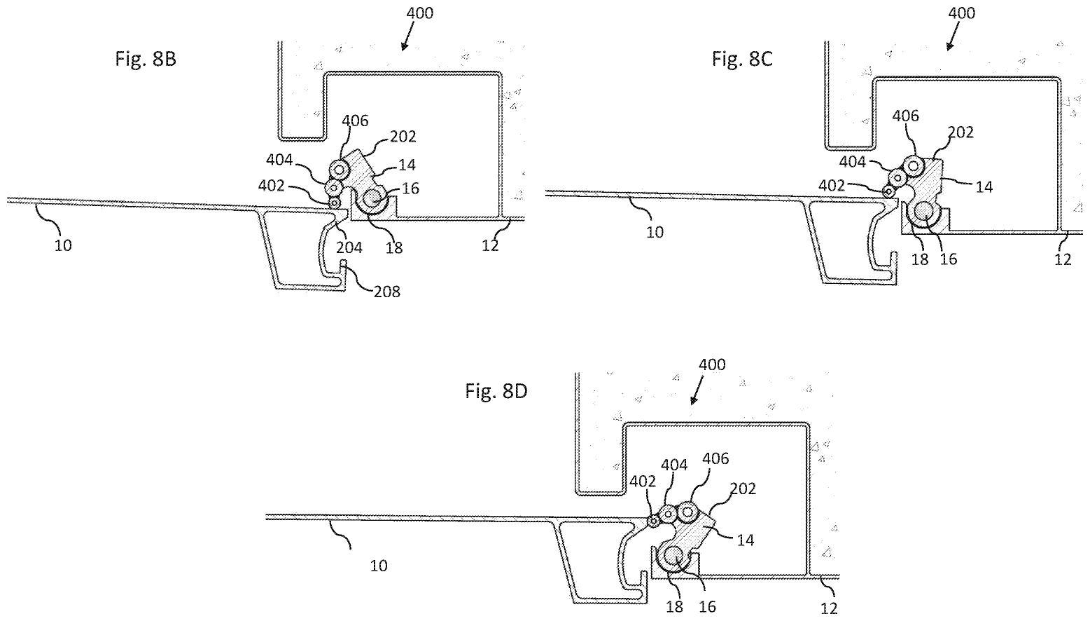

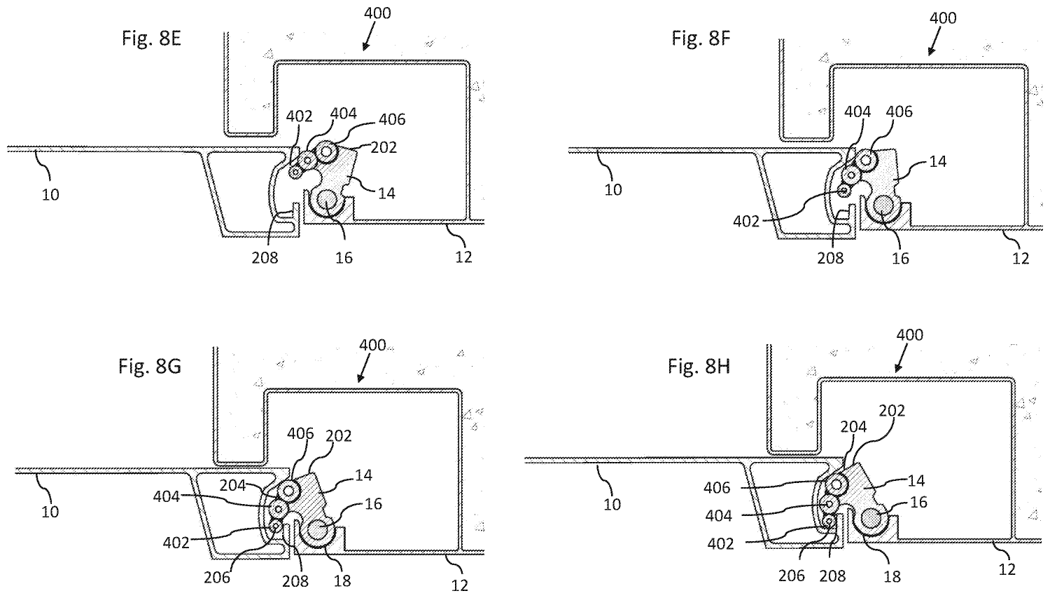

FIGS. 8A-8H illustrate an application of the roller elements feature to the locking arrangement of FIGS. 3A-4C. Specifically, in this locking arrangement, designated 400, a set of three roller element 402, 404 and 406, each similar to element 302 above, are deployed along hook region 206 and primary load bearing surface 202. In all other respects, locking arrangement IS 400 is similar in structure and function to locking arrangement 200 described above, with equivalent features labeled similarly. FIGS. 8B-8D illustrate the sequence of retraction of locking element 14 by closing of panel 10, while FIGS. 8E-8H illustrate the locking motion of locking element 14 at the end of the closing motion. It will be noted that the positioning of roller elements 402, 404 and 406 is chosen such that, throughout the motion, contact between panel 10 and locking element 14 occurs only through the rolling contact surfaces of the roller elements, thereby minimizing frictional wear and allowing for manufacturing tolerances. Here too, the roller elements preferably project from the underlying contact surfaces, particularly the active load bearing surfaces 202 and 206, maintaining an operating gap between the surfaces and their facing surfaces 204 and 208, which closes up during the initial stages of deformation when large forces or a blast are encountered.

The present invention has been illustrated herein with reference to locking arrangements for hinged panels. A default deployment of the locking arrangement is on the strike jamb, i.e., at the side opposite the hinge. It should be noted however that the various mechanisms described may equally be deployed on a frame edge adjacent to the hinge side, or in the context of a panel which has two modes of opening in which the effective hinge can be along either of two sides of the panel. The invention may also be applied to situations where a hinge axis is located in the middle of a panel, or at any other position across a panel, or where more complex hinge arrangements define a virtual hinge outside the area of the panel, or any more complex motion.

In all of the above embodiments, mechanical support for locking element 14 relative to frame 12 may be provided in a number of ways. Firstly, in various preferred implementations of the invention, locking element 14 is mounted on an axle which defines pivot axis 16. In some cases, the axle itself may be implemented as a sufficiently strong and supported structure to bear the loads which the locking mechanism is designed to withstand. In other implementations, the hinge axle is employed to support locking element 14 as it moves between its locked and unlocked positions, but is not relied upon for bearing major loading. In such cases, a region of locking element 14 around pivot axis 16 is preferably formed with a radius of curvature which matches to a partial cylindrical support wall 18 formed as part of frame 12. In this case, when significant force is applied to panel 10 while locked, slight flexing of the hinge axle allows closure of a small clearance gap between locking element 14 and support wall 18 so that most of the load is transferred directly to support wall 18.

As a further alternative (not shown), locking element 14 may be mounted on a load-bearing hinge, optionally of a type commonly referred to as a “piano hinge” which runs continuously along a length of locking element 14. The second wing of the hinge is fixed firmly to frame 12. By suitable choice of the hinge material, design and dimensions, it is possible to provide sufficient load bearing capability to withstand a wide range of expected loads for each given application.

The invention has been shown here schematically to illustrate the various implementations of the locking configuration, but omitting details of various additional mechanisms and features that are not required for an understanding of the invention. Specifically, practical implementations of a locking arrangement according to the present invention are typically combined with one or more actuation mechanism for displacing the locking element from its locked position to its unlocked position. These actuation mechanisms may be mounted in frame 12 and/or on panel 10, and may include any combination of manually operated handles, key-operated mechanisms, and powered actuator mechanisms (e.g., electrically powered, hydraulic or pneumatic). Examples of various suitable manual and powered actuation mechanisms may be found in US Pre-Grant Patent Application Publications US 2017/0254125 A1 and US 2017/0254119 A1, which were published on the same date as filing of this application and which do not constitute prior art.

Provision of a powered actuator to release locking of the panel may be useful in a range of circumstances where local or remote electronic control, or other remote control, is required. Examples include but are not limited to: push-button release systems, intercom systems, keypad code-operated systems, smart card and wireless access control systems, and various emergency access and emergency building evacuation arrangements. The system components (e.g., power supply, logic controller and communication interfaces, mechanical linkages, solenoids, motors etc.) required to support all such applications are well known in the art, and will not be addressed here in detail.

Additionally, implementations of the present invention may include various stop-latch or “deadlock” mechanisms which obstruct retraction of the locking element to its unlocked position while the panel is locked in its closed position. Here too, examples of suitable mechanisms may be found in the above-referenced patent publication.

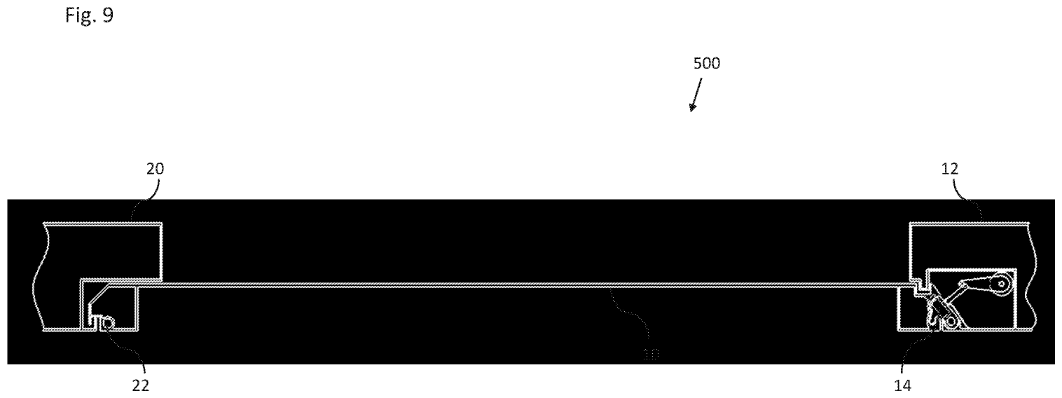

By way of one further preferred but non-limiting example, FIGS. 9-12F illustrate a locking configuration, generally designated 500, which combines an anchoring configuration similar to that of locking configuration 200 described above together with a deadlock arrangement (equivalent elements being labeled similarly) and a powered actuator mechanism. FIG. 9 shows an overview of the closure in which context the invention is used, including panel 10 mounted relative to a hinge jamb 20 at hinge 22 so as to close against a strike jamb portion of the frame 12, and to be locked in place by a locking element 14.

As in embodiment 200 above, the locking configuration here includes locking element 14 pivotally mounted about pivot axis 16 so as to assume a locked state in which a primary load bearing surface 202 is in facing relationship to pressure surface 204 and a hook region 206 is engaged under undercut 208. This example also features projecting ridge 222 and complementary slot 224, as described above with reference to FIG. 6A.

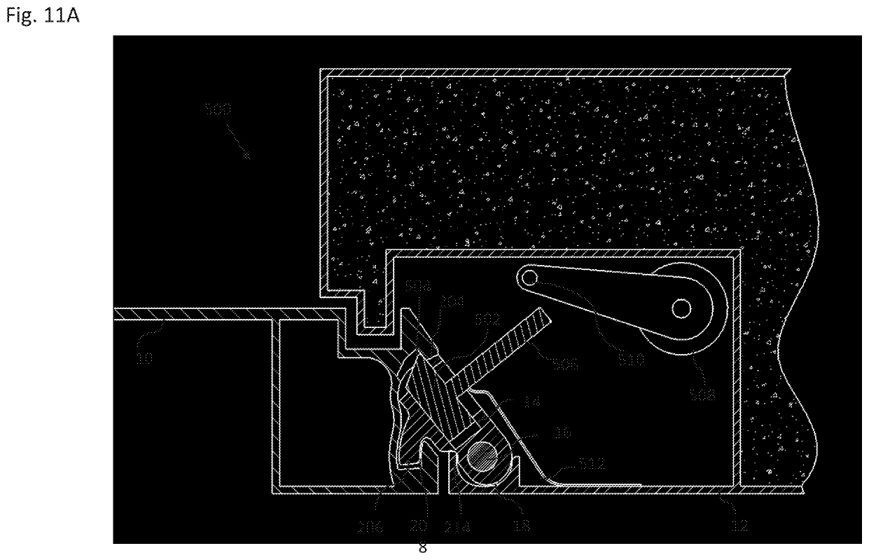

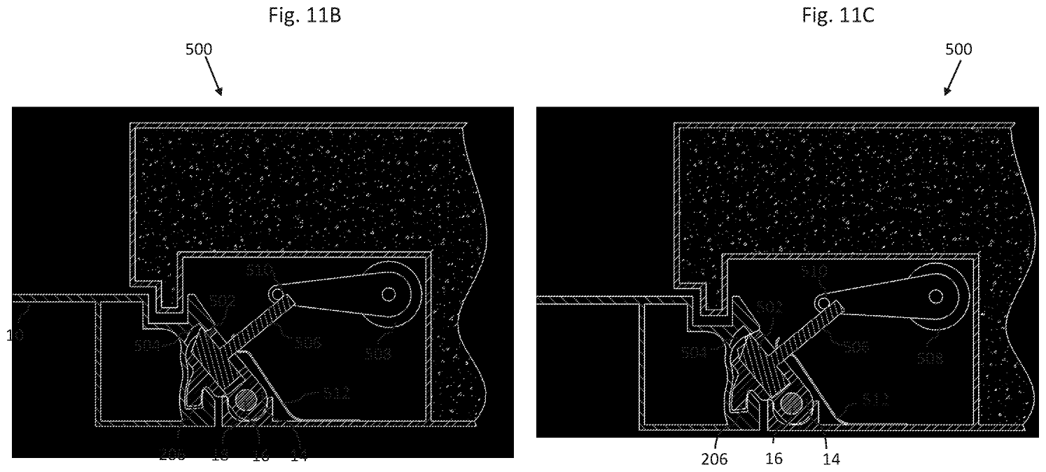

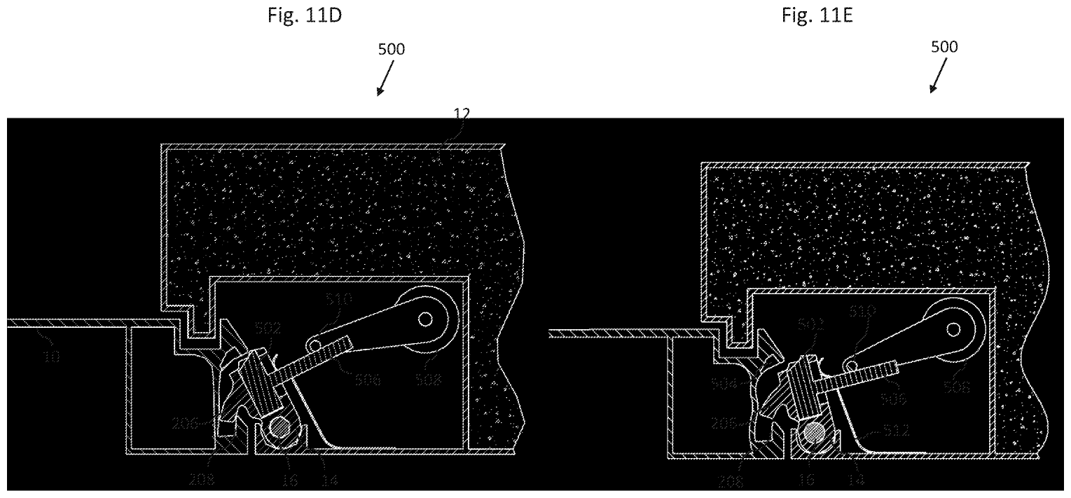

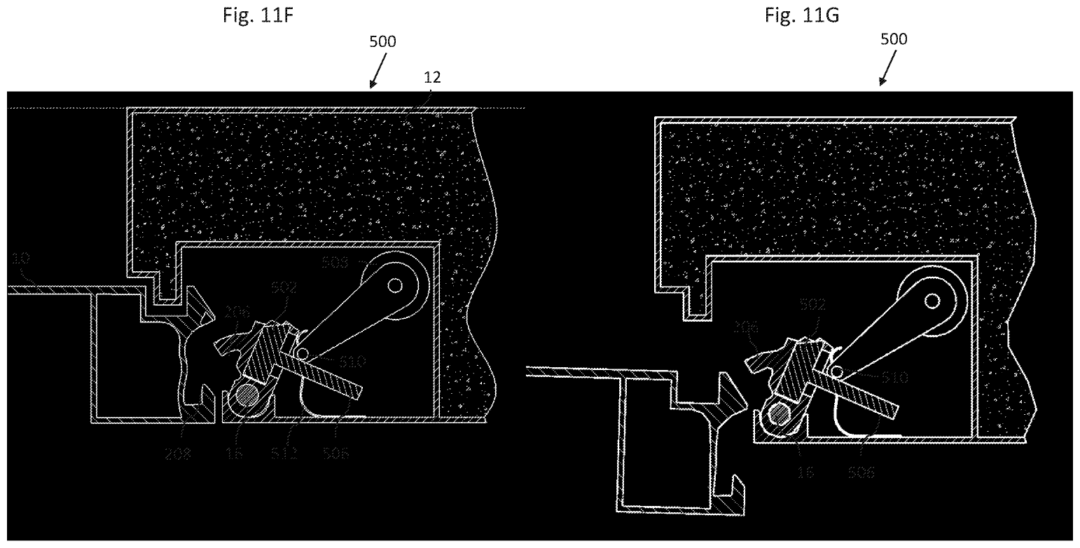

Locking arrangement 500 preferably also includes a locking latch arrangement, here implemented as an internal bolt 502 slidingly mounted within locking element 14 so as to assume an extended state (FIG. 11A) in which bolt 502 engages a recess 504 in pressure surface, thereby obstructing retraction of locking element 14 from its locked position. A lateral shank 506 projects outwards from bolt 502 through a slot in locking element 14. An actuator 508 with an actuator rotor 510 is deployed to selectively bear on lateral shank 506.

A sequence of operation of the actuator is shown in FIGS. 11B-11G. As the rotor 510 starts to move, it first engages lateral shank 506 (FIG. 11B). As it continues to move, the force applied to shank 506 forces bolt 502 to retract against a spring (not shown) within locking element 14, thereby disengaging the bolt from recess 504. Once bolt 502 has reached the end of its range of motion, further motion of rotor 510 causes locking element 14 to pivot about pivot axis 16 (FIGS. 11D-11F) against the bias of a leaf spring 512 until the locking element reaches its unlocked position, allowing swinging open of panel 10 (FIG. 11G).

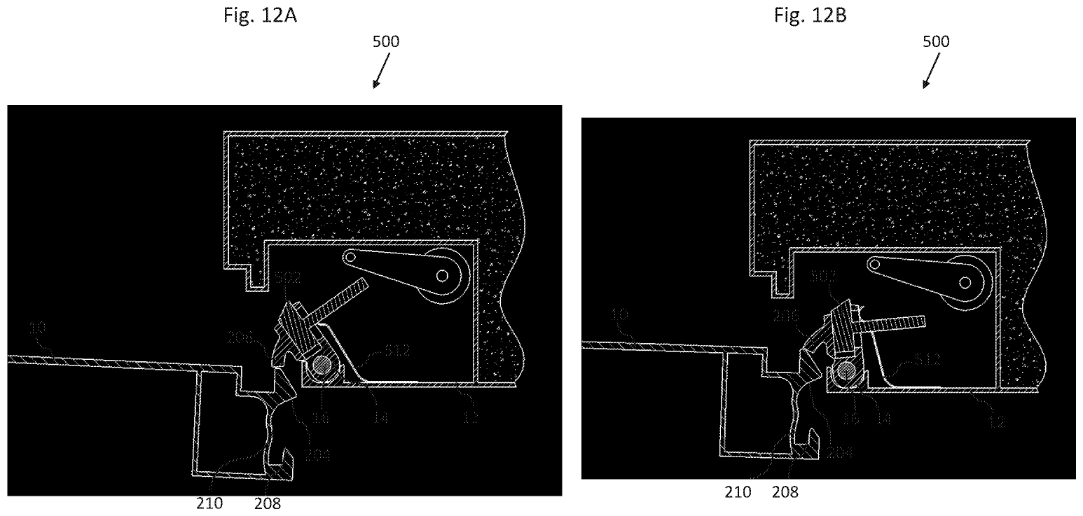

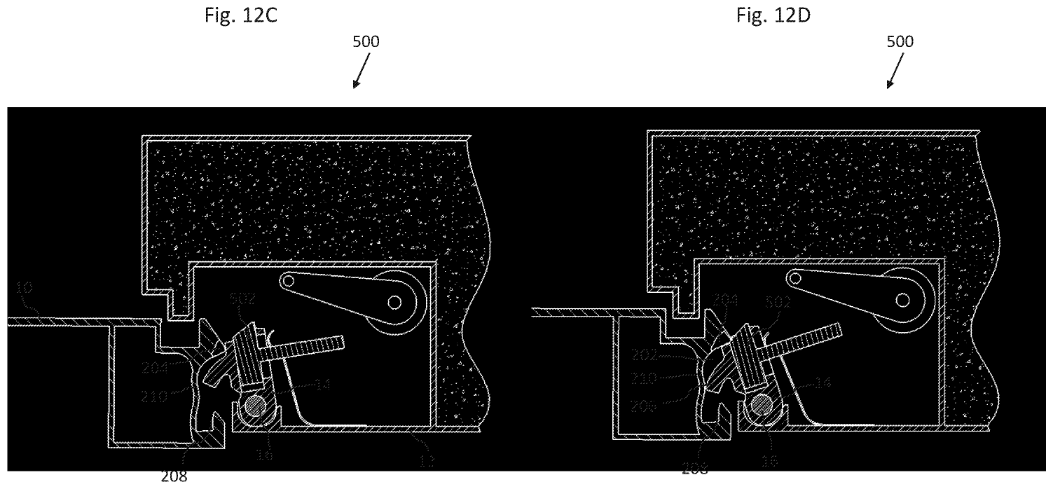

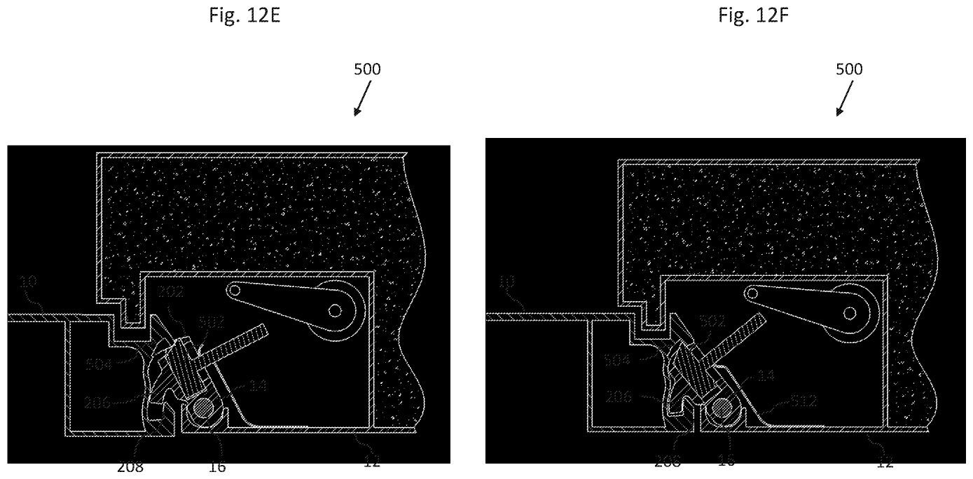

FIGS. 12A-12F illustrate a sequence of positions during closing of panel 10 without operation of actuator 508. The leading edge of panel 10 in this case first contacts hook region 206 (FIG. 12A) and forces locking element 14 to pivotally retract towards its unlocked position against the bias of leaf spring 512, as illustrated in FIGS. 12B and 12C. Continued closing motion of panel 10 allows locking element 14 to start to enter recess 210 of panel 10. As the engagement of locking element 14 with recess 210 progresses, part of pressure surface 204 (or a dedicated contact surface) of panel 10 bears on a beveled edge of bolt 502, causing it to retract (FIGS. 12D and 12E) until locking element reaches its fully locked position and bolt 502 engages recess 504, thereby providing the deadlock function to maintain the locked state.

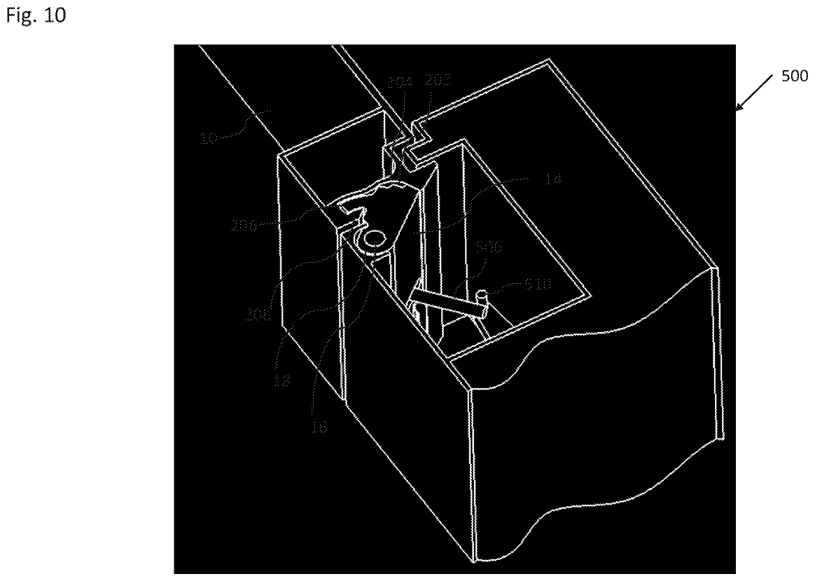

Optionally, as best seen in FIG. 10, primary load bearing surface 202 may optionally be implemented as a stepped surface with a sequence of steps each correctly oriented to lock in abutment with part of pressure surface 204. According to this option, even in the intermediate states of FIGS. 12D and 12E, before reaching the fully locked position, locking element 14 is effective to opposed forces trying to open panel 10 so that the panel is already effectively locked.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

It will be appreciated that the above descriptions are intended only to serve as examples, and that many other embodiments are possible within the scope of the present invention as defined in the appended claims.

1. An apparatus comprising:
(a) an opening bounded by a frame, said frame defining a plane of closure;
(b) a panel swingably mounted relative to said frame so as to be swingable between an open position removed from said opening and a closed position in which said panel is aligned parallel to said plane of closure; and
(c) a locking element mounted on said frame and displaceable between a locked position in which said locking element is engaged with said panel thereby locking said panel to said frame, and an unlocked position in which said locking element is disengaged from said panel thereby unlocking said panel from said frame, wherein said locking element comprises a primary load bearing surface deployed such that, when said panel is in said closed position and said locking element is in said locked position, said primary load bearing surface engages a pressure surface of said panel oriented at an inclination to said plane of closure such that force applied to displace said panel towards the open position is opposed by compressive forces applied by said pressure surface to said locking element acting towards said frame,
and wherein said locking element further comprises an anchoring configuration configured such that, when said panel is in said closed position and said locking element moves to said locked position, said anchoring configuration engages a complementary feature of said panel to define a tensile engagement configured to oppose forces acting within said plane of closure to separate said panel from said frame.

2. The apparatus of claim 1, wherein said primary load bearing surface and said anchoring configuration are rigidly interconnected or integrally formed as part of said locking element.

3. The apparatus of claim 1, wherein said locking element is pivotally mounted to said frame.

4. The apparatus of claim 3, wherein said anchoring configuration comprises a hook region of said locking element, and wherein said complementary feature of said panel is an undercut surface in a recess of said panel.

5. The apparatus of claim 4, wherein said locking element is pivotally mounted so as to be pivotable about a pivot axis, and wherein at least part of an engagement contact area between said hook region and said undercut surface is located to the door-opening side of a plane parallel to said plane of closure passing through said pivot axis.

6. The apparatus of claim 3, wherein said frame comprises a stopper deployed to abut a surface of said locking element in said locked position so as to limit rotation of said locking element,

7. The apparatus of claim 1, wherein at least part of said primary load bearing surface is a flat surface, and at least part of said pressure surface is a flat surface.

8. The apparatus of claim 1, wherein said locking element is resiliently biased to move from said unlocked position towards said locked position, and wherein said locking element further comprises a roller element deployed so as to provide a rolling contact surface positioned to be contacted by said panel on swinging from said open position to said closed position, thereby displacing said locking element towards said unlocked position to allow closing of said panel.

9. An apparatus comprising:
(a) an opening bounded by a frame, said frame defining a plane of closure:
(b) a panel swingably mounted relative to said frame so as to be swingable between an open position removed from said opening and a closed position in which said panel is aligned parallel to said plane of closure; and
(c) a locking element mounted on said frame so as to be pivotable about a pivot axis parallel to an edge of said panel between a locked position in which said locking element is engaged with said panel thereby locking said panel to said frame, and an unlocked position in which said locking element is disengaged from said panel thereby unlocking said panel from said frame,
wherein said locking element comprises a convex primary load bearing surface deployed such that, when said panel is in said closed position and said locking element is in said locked position, forces applied to said panel directed to displace said panel towards said open position are transferred via said primary load bearing surface to said frame,
and wherein a region of said panel contacting said convex primary load hearing surface has a shape non-complemental to said convex primary load bearing surface so as to accommodate sliding motion of said region of contact over said convex primary load bearing surface resulting from flexion deformation of said panel while maintaining effective force transfer from said panel to said locking element.

10. The apparatus of claim 9, wherein said convex primary load bearing surface has a partial cylindrical form.

11. The apparatus of claim 10, wherein said pivot axis is an axis of said partial cylindrical form.

12. The apparatus of claim 9, wherein said convex primary load bearing surface has an angular extent of at least 30° around said pivot axis.

13. The apparatus of claim 9, wherein said frame further comprises an angular stop deployed to abut part of said locking element in said locked position so as to prevent pivoting of said locking element beyond said locked position.

14. The apparatus of claim 9, wherein said region of said panel contacting said convex primary load bearing surface is an edge of said panel.

15. The apparatus of claim 9, wherein said region of said panel contacting said convex primary load bearing surface is a flat region.

16. The apparatus of claim 9, wherein said region of said panel contacting said convex primary load bearing surface is a convex region.

17. (canceled)

18. (canceled)

19. (canceled)

20. The apparatus of claim 1, wherein said locking element is an elongated locking element extending parallel to an edge of said panel and extending along at least about 1.0% of a length of said edge of said panel.

21. The apparatus of claim 1, wherein said locking element is an elongated locking element extending parallel to an edge of said panel and extending along a majority of a length of said edge of said panel.
